(19) United States
(12) Patent Application Publication
(10) Pub. No.: US 2014/0240806 A1
(43) Pub. Date: Aug. 28, 2014

(54) Holographic exposing and capturing screens

(71) Applicant: Igor Semenovich Chernov, Sankt-Petersburg (RU)

(72) Inventor: Igor Semenovich Chernov, Sankt-Petersburg (RU)

(21) Appl. No.: 13/775,130

(22) Filed: Feb. 23, 2013

(51) Int. Cl. G03H 1/26

(52) U.S. Cl. CPC G03H 1/26
USPC 359/9

(57) ABSTRACT

This invention offers the construction of the holographic screen exposing and capturing three-dimensional video images. Exposing holographic screen is the construction comprising two screens placed on the certain distance from each another. The rear screen is the matrix of the light emitting elements. The front screen is the matrix of the light transmitting elements. In the certain moment the matrix of the rear screen provide the introjection of the image passing through the transparent point of the front screen making the anisotropic emission of the desired configuration. In the next time slice the introjection of the next image occurs through the neighboring point etc. The construction of the capturing holographic screen is the same with the construction of the exposing holographic screen, but the rear screen is the light absorbing matrix instead of the light emitting.

### CROSS-REFERENCE TO RELATED APPLICATIONS

Not Applicable

### BACKGROUND OF THE INVENTION

Currently the widespread devices, that exposing three-dimensional video images, are the stereoscopic screens, that supply the different video streams in the left and right eyes of the observer, and the devices, that capturing three-dimensional video images, are the stereoscopic cameras (the system with two video cameras, that capturing the stereoscopic images basing on the parallax effect). The main feature of the stereoscopic image is that any observer (independently of its position in front of the exposing screen) related to the content of the observed image is located in the virtual point of the image capture (the point same for all observers where the stereoscopic camera was positioned in the moment of capture, FIG. 2).

Less widespread devices are the holographic exposing screens where any observer in any point in front of the exposing screen has the possibility to be in its own point of the virtual space that is the direct prolongation of the space in front of the capturing screen near the captured objects (FIG. 3). The examples of the natural holographic screen are a window with a transparent glass and a mirror. Currently an artificial holographic screens are difficult in making and the prior art doesn't let the capturing and exposing of dynamic video images to be practicable.

The main feature of the exposing holographic screen is that every its point should emit the anisotropic emission of the certain configuration. As yet such a configuration is made basing of the interference and the diffraction of the coherent emission on the elements of the capturing photo surface (for example the U.S. Pat. No. 6,288,805 and U.S. Pat. No. 6,002,500) or the controlled deflection of the emission on the certain angles (for example the U.S. Pat. No. 7,503,656).

### BRIEF SUMMARY OF THE INVENTION

This invention offers the construction of the holographic screen exposing and capturing three-dimensional video images.

Exposing holographic screen is the construction comprising two screens placed on the certain distance from each another. The rear screen is the matrix of the light emitting elements. The front screen is the matrix of the light transmitting elements. In the certain moment the matrix of the rear screen provide the introjection of the image passing through the transparent point of the front screen making the anisotropic emission of the desired configuration. In the next time slice the introjection of the next image occurs through the neighboring point etc.

The construction of the capturing holographic screen is the same with the construction of the exposing holographic screen, but the rear screen is the light absorbing matrix instead of the light emitting (FIG. 1).

The advantage of this invention is that the construction of this is fully independent on the spectrum and intensity of the light.

### BRIEF DESCRIPTION OF THE SEVERAL VIEWS OF THE DRAWING

The FIG. 1 shows the construction of the holographic exposing or capturing screens.

The FIG. 2 shows the feature of the stereoscopic exposing screens, whereby each observer independently of its position in front of the exposing screen sees the same with others, specifically what saw the stereoscopic capturing camera in the moment of capture.

FIG. 3 shows the feature of the holographic exposing screens, whereby each observer situated in its own position in front of the exposing screen sees what it could see situating in the same position behind the transparent glass near the captured objects.

FIG. 4 shows the construction of the “camera clara” like the camera obscūra where the matrix of the light emitting elements is used instead of the projection surface.

FIG. 5 shows the solution for the holographic exposing screen whereby the virtual “camera clara” (cell) is shifted on one pixel of the light transmitting matrix in the next time slice.

FIG. 6 shows the moving trajectory of the open sate of the pixels of the light transmitting screen (the pixel is assumed to be “open” if it's transparent, otherwise—“closed”). Every such a trajectory seems like the scanning in the electronic ray tubes. The scanning occurs over the areas that size is equal to the size of the “camera clara”. The form of this trajectory (the actual sequence of the opening events) can be any.

FIG. 7 shows the principal of the tuning of the transmitting screen thickness, whereby we can avoid the introjection of the neighboring cells areas of the emitting screen through the pixels of the transmitting screen.

FIG. 8 shows the solution for the holographic capturing screen, whereby the virtual camera obscūra (cell) is shifted on one pixel of the light transmitting matrix in the next time slice.

FIG. 9 shows the transmitting pixel of the front screen matrix of the holographic screen that is equipped with the concave lens. This allows reducing the distance between the front and rear screens.

FIG. 10 shows the transmitting pixel of the front screen matrix of the holographic screen that is equipped with the concave lens with the adumbrative layer of the certain intensity configuration. For the capturing screen this allows providing even distribution of the illumination over the cell area from its center to the edges. For the exposing screen this allows providing even distribution of the illumination intensity from the pixels of the emitting surface passing through the transmitting pixel of the cell.

Here 1 is the distribution function whether of the illumination of the capturing surface pixels from the light passing through the cell transmitting pixel for the capturing screen, or of the illumination intensity from the emitting pixels passing through the transmitting pixel of the cell of the exposing screen.

FIG. 11 shows the amount of the elements in the monic spatial angle with that the observer sees the corresponding pixels area on the screen.

FIG. 12 shows the maximal view angle with that the observer situating on the orthogonal axis passing through the center of the screen can see the whole screen comfortable.

FIG. 13 shows the assumption about the equality of the view angle element with that the observer sees one pixel of the emitting matrix and the displacement angle element that the observer needs to see the neighboring pixel of the emitting matrix through the certain pixel of the transmitting matrix.

FIG. 14 shows the amount of the pixels of the emitting matrix that the observer can see through the certain open pixel of the transmitting matrix deviating in the range of the monic spatial angle.

FIG. 15 shows the maximal observation angle with that the observer can see the emission of the holographic screen points.

FIG. 16 shows the relationship of the resolutions of the emitting and transmitting matrixes. The linear size of the transmitting matrix pixels of the front screen should be in two times less than the linear size of the emitting matrix pixels. Because the pixel resolution of matrixes is inversely with its square the ratio of its resolutions will be the four to one.

FIG. 17 shows the necessity to increase in four times the resolution of the transmitting matrix relative to the emitting matrix. That forces also to increase in four times the amount of the flat images to play one frame of the holographic video image relative to the amount of the pixels in the area of the “camera clara” cell of the emitting matrix.

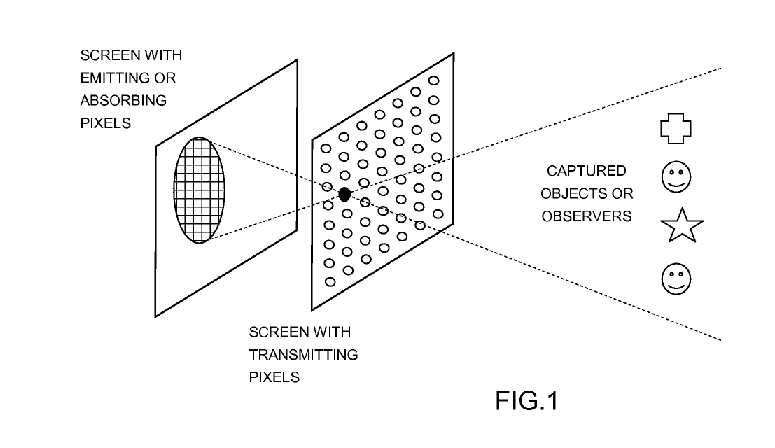

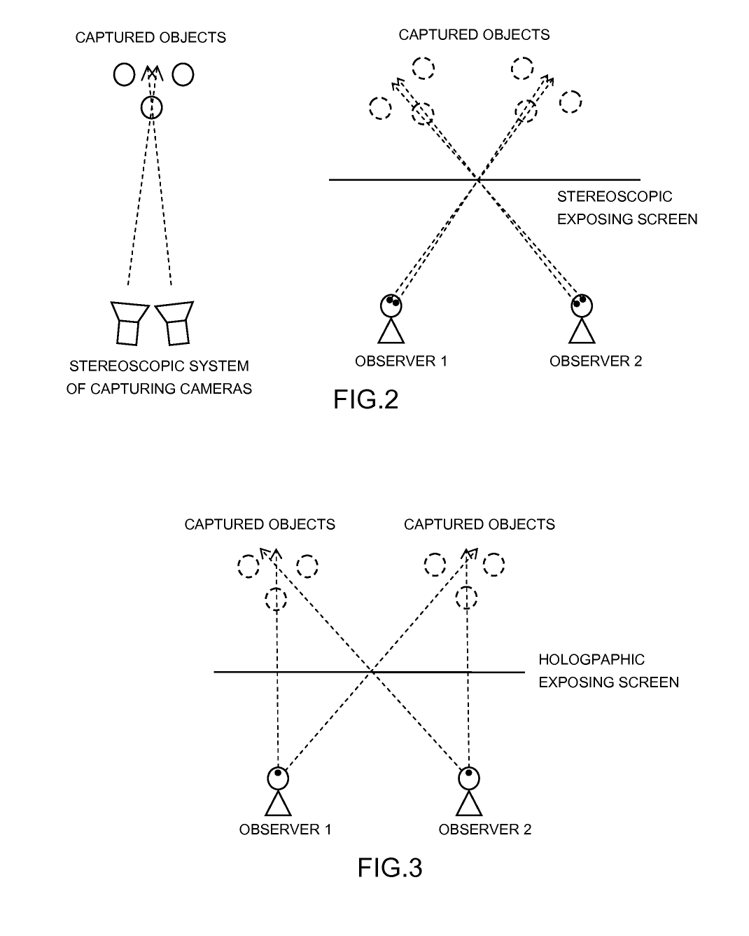

### DETAILED DESCRIPTION OF THE INVENTION

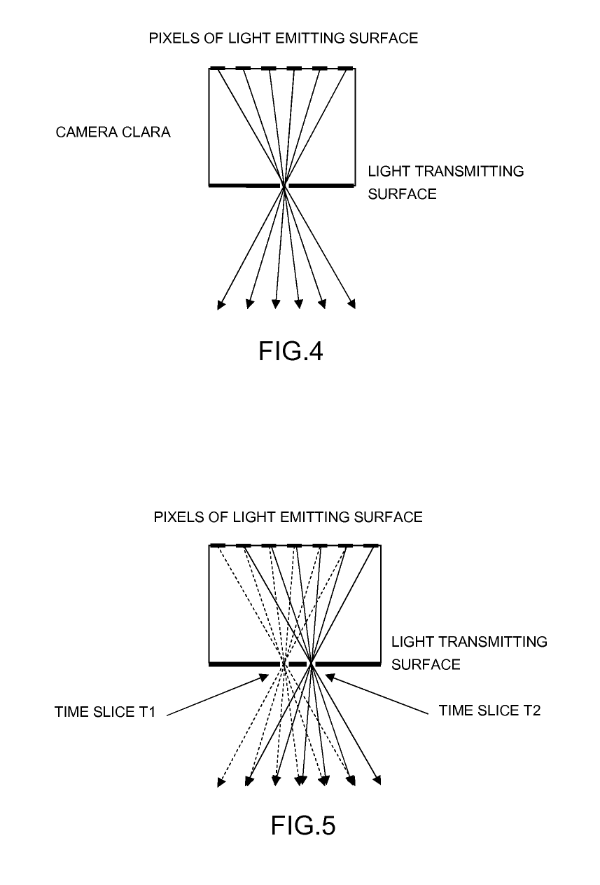

The main feature of this invention is that the way to make the anisotropic emission of the point is the introjection(*) of the image from the emitting surface through the transparent point in the opaque screen, placed on the certain distance off the image emitting surface. This construction is like the camera obscūra backward (FIG. 4). Let's call that construction “camera clara”(**). If we assume that the exposing screen should consist of such transmission points then the practical disadvantage of such constructions is that the transmission points cannot be allocated from each another closely than the size of such a camera (cell). But the appropriated distance between the emission points of the exposing screen (pixels), should not exceed the size of pixels itself.
* The term introjection was offered by the Hungarian psychoanalyst Sándor Ferenczi as the antonym for the term projection.

** The translation from the Latin the camera obscūra is the “dark room”. The antonym for this is the “clear room”, that by the translation to the Latin gets the “camera clara”.

The solution offered by this invention, that lets eliminate this disadvantage, is the combination of the areas of the emitting surface in the one common for the several neighboring points of the transmitting surface. And to avoid the images intersect each another the introjections through every neighboring transmission point are separated into the time slices (made serially for every neighboring point, FIG. 5).

This invention offers the construction of the holographic screen consists of the two screens placed on certain distance from each another. For the exposing holographic screen the rear screen is the matrix of the light emitting elements (emitting pixels). The front screen is the matrix of the light transmitting elements (transmitting pixels) they either transmit or not the emission of the rear screen depending of the controlling signal. Let's call the pixel “open” when it's transparent, otherwise—“closed”.

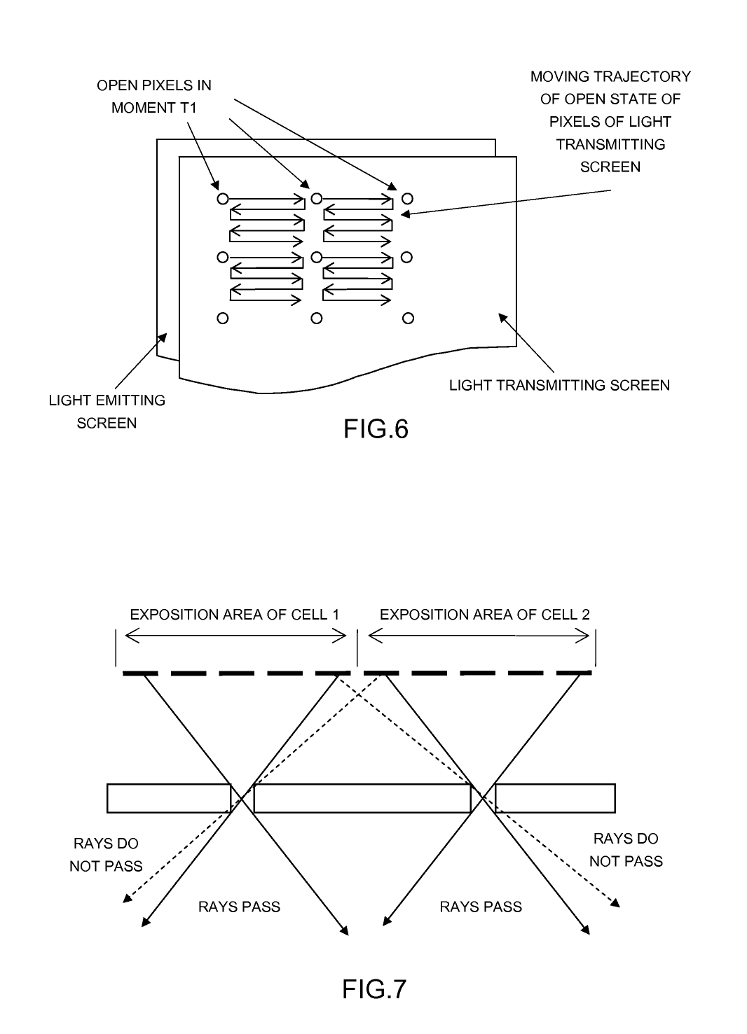

In the certain moment open are the pixels of the front screen that distant from each another on the size of the cell (the virtual “camera clara”) and the rear screen emits the images corresponding to the areas behind these open transmitting pixels. In the next time slice on the front screen the open become the pixels neighboring to the previous and the image of the rear screen changes to the necessary for the introjection through these neighboring pixels, etc. Herewith, every open point of the front screen serially traverse over the area with the size of the cell (the rectangle between the simultaneously open pixels) doing something like the scanning in the electronic ray tubes (FIG. 6). The actual sequence of the traverse of the open points can be any.

To avoid transmitting by the open pixel of the certain front screen cell the light from the pixels of the neighboring cells of the rear screen, the corresponding thickness of the front screen is adjusted (FIG. 7).

The construction of the capturing holographic screen is the same with the construction of the exposing holographic screen, but the rear screen is the matrix of the light absorbing pixels instead of the light emitting pixels (FIG. 8).

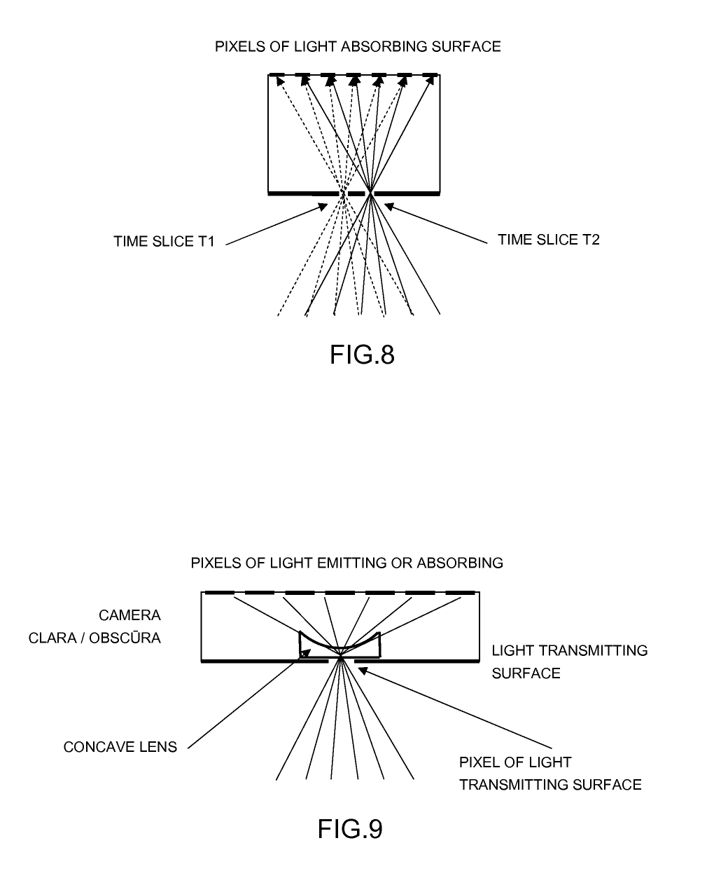

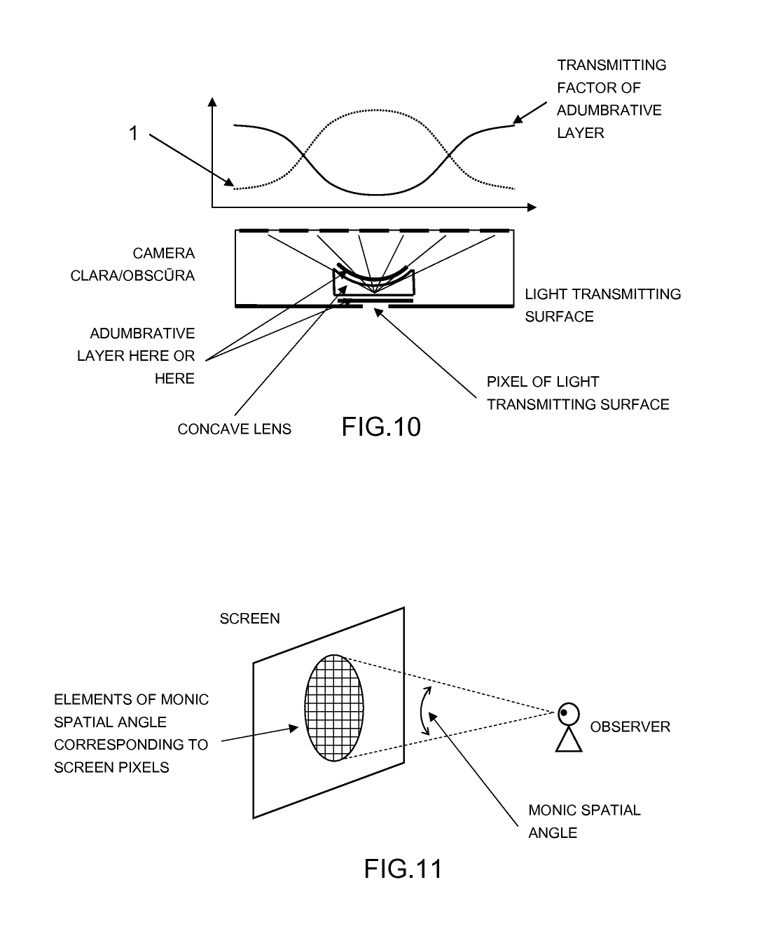

For both types of the holographic screens, capturing and exposing, the transmitting pixels of the front screen matrix can be equipped with the concave lenses that allows reducing the distance between the front and rear screens (FIG. 9). These lenses can be equipped with the adumbrative layer of the certain intensity configuration that allows providing even distribution of the illumination over the cell area from its center to the edges (FIG. 10).

### Realization of the Invention

### Common Calculating Formulas

Consider the observer looks on the screen. The practical characteristics that have an influence on the quality of the observed image are the screen size, the distance from the observer to the screen and the screen resolution. Meanwhile all these three parameters are linearly dependent relative to the image quality. Increasing the size of the screen and the size of its pixels (leaving its amount fixed) and increasing the distance from the observer to the screen the observed image quality can be leaved unchanged. Therefore, as the characteristic of the image quality of the monoscopic matrix screen, let us introduce the term “Projection angle resolution”:

$${Δ}_{p} \approx \frac{{Θ}_{p}}{{ϒ}_{p}}$$

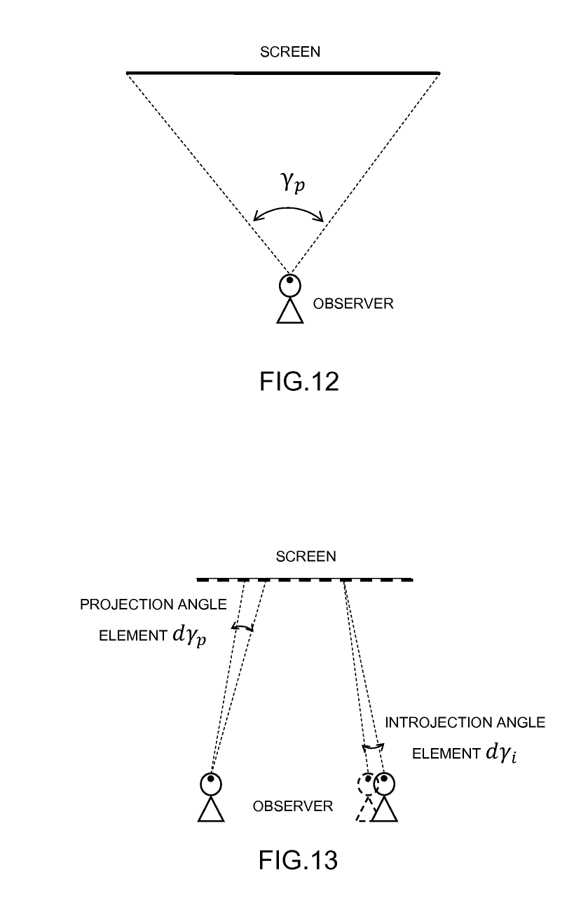

Δₚ—Projection angle resolution of the screen—the amount of the elements in the monic spatial angle of the projection (FIG. 11);
Θₚ—Capacity of the screen—the whole amount of the pixels of the monoscopic screen matrix;
γₚ—Maximal projection angle—the maximal observation angle with that the observer situating on the orthogonal axis passing through the center of the screen can see the whole screen comfortable (FIG. 12);

For the monoscopic screen the observer has only one virtual viewpoint—the point where the camera was at the moment of capture. To play one frame of the monoscopic image for this point you will need one flat image (one array of the scalar values with the dimension of the screen capacity). To play one frame of the stereoscopic image you will need two flat images (two such arrays). To play one frame of the holographic image you will need so many flat images how many independent viewpoints we intend to have. Based on the symmetry we can assume that acceptable will be the amount equal to the acceptable amount of the pixels of the monoscopic screen placed on the minimal distance from the observer so that the observer can see the whole screen. If we introduce the term “Introjection angle resolution” then we can assume that the acceptable projection angle resolution will be equal to the acceptable introjection angle resolution. Or in other words, the size of the projection angle element should be equal to the size of the introjection angle element (FIG. 13):

$${Δ}_{i} \approx \frac{{Θ}_{i}}{{ϒ}_{i}} ;$$

$${Δ}_{p} = {Δ}_{i} ≡ Δ ;$$

$${Θ}_{p} = {Θ}_{i} = {Θ}_{γ} ≡ Θ ;$$

$${ϒ}_{p} = {ϒ}_{i} ≡ ϒ$$

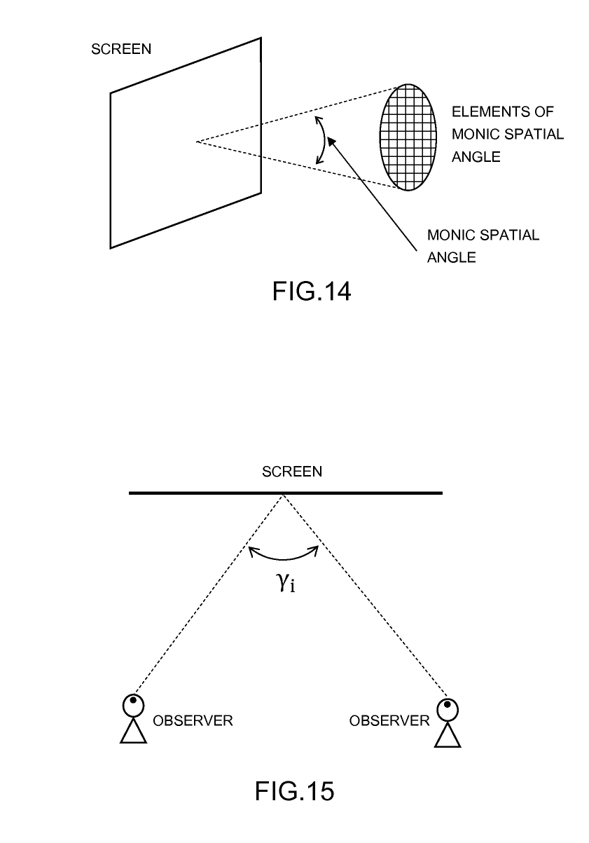

Δᵢ—Screen introjection angle resolution—the amount of the elements in the monic spatial angle of the introjection (FIG. 14);
Θᵢ—Amount of viewpoints—the whole amount of the points of the surface that is placed in front of the holographic screen from that the distinct emission of the point of the holographic screen can be seen;
γᵢ—Maximal introjection angle—the maximal observation angle with that the observer can see the emission of the holographic screen points (FIG. 15);
Δₚ—Projection angle resolution of the screen—the amount of the elements in the monic spatial angle of the projection;
Δ—Screen angle resolution—the amount of the elements in the monic spatial angle;
Θₚ—Capacity of the screen—the whole amount of the pixels of the monoscopic screen matrix;
Θ_{γ}—Frame angle capacity—the whole amount of the elements in the maximal introjection angle;
Θ—Frame capacity—the amount of the flat images necessary to play one holographic frame equal to the amount of the pixels of the emitting matrix of the single “camera clara”;
γₚ—Maximal projection angle—the maximal observation angle with that the observer situating on the orthogonal axis passing through the center of the screen can see the whole screen comfortable;
γ—Screen maximal angle—the maximal angle of view with that the observer can see the whole screen comfortable equal to the observation angle with that the observer can see the point of the screen;

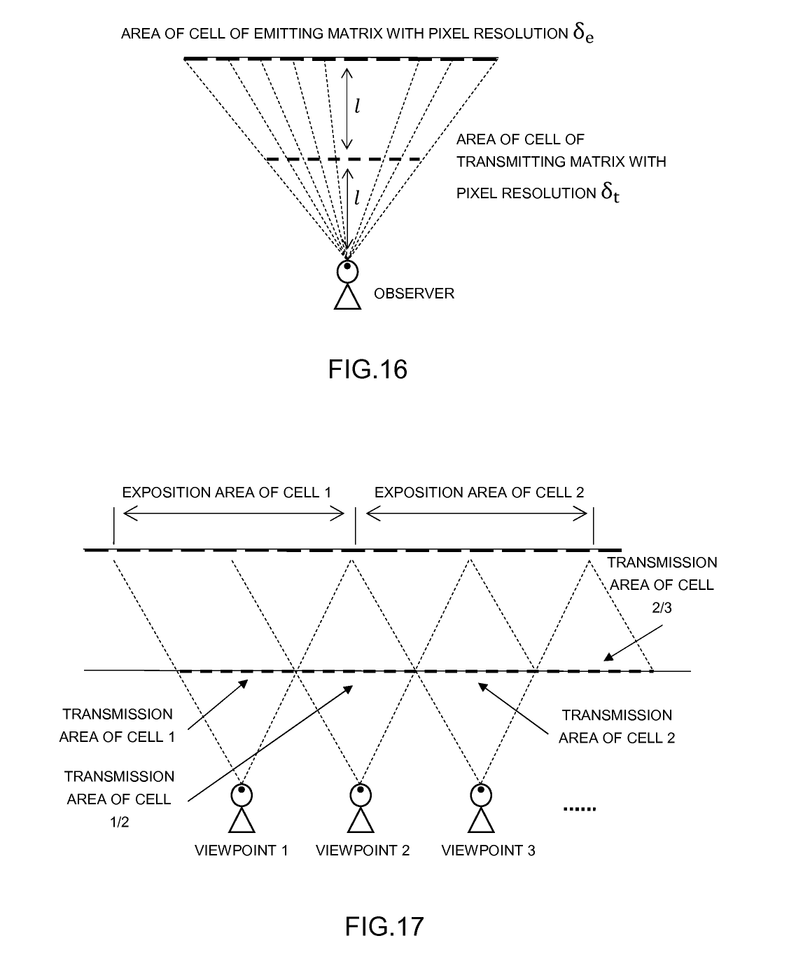

Hence we have got that to get the certain angle resolution Δ the <<camera clara>> should provide the introjection from the area of the pixels with the amount of Θ on the angle γ. If we consider the surface of the points, nearest to the screen, from that the whole screen will be seen with the observation angle γ then we get that for the single simple “camera clara” the transmitting screen should be placed in front of the observer on the same distance (l) with the distance between the transmitting and emitting screens. And to provide the most detail visibility of the emitting pixels through the transmitting pixels from the points of this nearest surface the linear size of the transmitting matrix pixels of the front screen should be in two times less than the linear size of the emitting matrix pixels. Herefrom we can find the ratio of the resolutions of these matrixes (FIG. 16):

δₜ=2²δₑ=4δₑ
δₜ—Pixel resolution of the transmitting screen—the amount of the pixels in the monic area of the transmitting screen;
δₑ—Pixel resolution of the emitting screen—the amount of the pixels in the monic area of the emitting screen;

Moving the observer out of the screen the necessary resolution δₜ could be decreased and this approach δₚ by moving the viewpoint to the infinity. Therefore assuming the δₜ=4δₑ we maximally match the requirement for the ultimate characteristic.

Hence if we want to build the holographic screen from the cells kind of the “camera clara” then each of that should be aggregate. I.e. the area size of the rear emitting screen should be equal to the area size of the front transmitting screen (to provide the continuity of the transmitting capability over the whole screen, FIG. 17). As consequence, the necessary amount of the flat images to play one holographic frame from the aggregated “camera clara” (equal to the amount of the pixels in the transmitting area of the “camera clara” of the front screen) should be equal to the 4Θ. Meanwhile the distance between the emitting and transmitting screens can be found from the formula

$${l}_{d} = {l}_{v} \sqrt{\frac{Θ}{S * {δ}_{e}}} \approx {l}_{v} \sqrt{\frac{Θ}{{l}_{v}^{2} * {δ}_{e}}} = \sqrt{\frac{Θ}{{δ}_{e}}}$$

l_{d}—the distance between the emitting and transmitting screens;
lᵥ—the minimal distance between the observer and the transmitting screen;
Θ—Frame capacity—the amount of the flat images necessary to play one holographic frame equal to the amount of the pixels of the emitting matrix of the single “camera clara”;
S—the whole area of the screen;
δₑ—Pixel resolution of the emitting screen—the amount of the pixels in the monic area of the emitting screen;

### Sample of the Certain Values

Let's take the maximal screen angle γ=1 st (one steradian). Let's take as the acceptable the frame capacity Θ=640*480≈308 Kpix. Let's take the emitting matrix resolution δₑ≈2.4 Gpix/m² (the transmitting matrix resolution will be δₜ≈9.6 Gpix/m²).

Hence we get the distance between the emitting and transmitting screens l_{d}≈0.01 m. If we take the screen area S=0.2 m*0.3 m=0.06 m² then the minimal distance between the observer and the screen will be lᵥ≈0.22 m. Let's take the rate of the holographic frames equal to the 50 fps (frames per second). Then the rate of the transmission of the flat images we get about 61.6 Mfps (millions of frames per second). Every such an image should comprise about 144 Mpix.

1. The device comprising two screens placed on certain distance from each another where the front screen called transmitting is the matrix of the elements transmitting the light depending of the controlling signal and the rear screen is the matrix of the elements emitting the light depending of the controlling signal,
meanwhile the pixel of the transmitting screen called open if it's transparent, otherwise—closed,
meanwhile the ratio of the distance between the front and rear screens, the thickness of the matrix of the front screen and the width of the transmitting elements of this matrix determines the zone of the visibility of the elements of the rear screen through the elements of the front screen, meanwhile the size of such a zone determines the cell;
in the certain moment open have been made the pixels of the front screen distant from each another on the size of the cell and on the rear screen has been put the image with help of that the necessary configuration of the anisotropic ray is provided, called introjection, trough this open pixels of the front screen;
in the next time slice on the front screen open become the pixels neighboring with the previous and on the rear screen has been put the next image necessary to provide the introjection trough this open pixels of the front screen;
thereby the open sate of every open pixel of the front screen serially traverse over the area with the size of the cell (the rectangle between the simultaneously open pixels) making the scanning over this area, meanwhile the form of the trajectory of this scanning can be any.

2. The device as claimed in claim 1, wherein the transmitting pixels of the front screen matrix are equipped with the concave lenses of such configuration that allows reducing the distance between the front and rear screens keeping the size of cell unchanged.

3. The device as claimed in claim 2, wherein the concave lenses of the transmitting pixels of the front screen matrix are equipped with the adumbrative layer such intensity configuration that allows providing even over the cell area from its center to the edges distribution of the illumination intensity from the pixels of the emitting surface passing through the transmitting pixel of the cell.

4. The device comprising two screens placed on certain distance from each another where the front screen called transmitting is the matrix of the elements transmitting the light depending of the controlling signal and the rear screen is the matrix of the elements absorbing the light projection passing through the elements of the front screen,
meanwhile the pixel of the transmitting screen called open if it's transparent, otherwise—closed,
meanwhile the ratio of the distance between the front and rear screens, the thickness of the matrix of the front screen and the width of the transmitting elements of this matrix determines the zone of the accessibility of the elements of the rear screen for the light passing through the elements of the front screen, meanwhile the size of such a zone determines the cell;
in the certain moment open are the pixels of the front screen distant from each another on the size of the cell and from the rear screen has been got the signal corresponding the image projected through the open pixels of the front screen;
and in the next time slice on the front screen open become the pixels neighboring with the previous and from the rear screen has been got the signal corresponding the next image projected through the open pixels of the front screen,
thereby the open sate of every open pixel of the front screen serially traverse over the area with the size of the cell (the rectangle between the simultaneously open pixels) making the scanning over this area, meanwhile the form of the trajectory of this scanning can be any.

5. The device as claimed in claim 4, wherein the transmitting pixels of the front screen matrix are equipped with the concave lenses of such configuration that allows reducing the distance between the front and rear screens keeping the size of cell unchanged.

6. The device as claimed in claim 5, wherein the concave lenses of the transmitting pixels of the front screen matrix are equipped with the adumbrative layer such intensity configuration that allows providing even distribution over the cell area from its center to the edges of the illumination of the pixels of the capturing surface.
